(19) United States
(12) Patent Application Publication
(10) Pub. No.: US 2015/0015012 A1
(43) Pub. Date: Jan. 15, 2015

(54) DEVICE FOR PULLING THE RELEASE LEVER OF A TRACTOR TRAILER AND METHOD THEREFOR

(71) Applicant: MARK COLEMAN, FLAGSTAFF, AZ (US)

(72) Inventor: MARK COLEMAN, FLAGSTAFF, AZ (US)

(21) Appl. No.: 13/934,513

(22) Filed: Jul. 3, 2013

(51) Int. Cl. B25J 1/04; B66F 19/00

(52) U.S. Cl. CPC B25J 1/04; B66F 19/00
USPC 294/175

(57) ABSTRACT

A device for pulling and or twisting a release arm on a side of a fifth wheel of a tractor to release the tractor from the trailer has an elongated hollow body member. A hook member is attached to a bottom section of the elongated hollow body member. A rod member is positioned within the elongated hollow body n ember, wherein the rod member moved up and down within the elongated hollow body member. A locking mechanism is used to lock the rod member in a retracted position within the elongated hollow body member and in an extended position within the elongated hollow body ember.

### RELATED APPLICATIONS

The present patent application is related to U.S. Provisional Application Ser. No. 61/741,337, filed Jul. 18, 2012, in the name of the same inventor listed above, and entitled, “Clean Release Telescopic 5th In Wheel Release Tool For Semi Tractor/Trailers”. The present patent application claims the benefit under 35 U.S.C. §119(e)

### TECHNICAL FIELD

The present invention relates generally to a tractor-trailer and, more specifically, to a device for pulling and or twisting a release arm to uncouple the trailer from the tractor.

### BACKGROUND

The trucking industry is an essential element in our interstate commerce system. Shipment of goods by tractor-trailer rig is an inexpensive way to distribute goods throughout the country. One drawback to tractor-trailer rig is that the trailer must be coupled to and uncoupled from the tractor. Coupling and uncoupling (or hooking and unhooking) is a simple and fast process. However, if done incorrectly, this process may result in injury to the driver.

Coupling and uncoupling the tractor-trailer rig can be done as follows. The tractor is equipped with a fifth wheel that pivots as the tractor is back up under, or pull out from under, a trailer. A kingpin on the trailer slides up into the fifth wheel and the fifth wheel jaws latch closed, around the shank of the kingpin. In order to open the jaws, one must pull a release arm on the side of the fifth wheel. The problem with pulling on the release arm is that one must stretch underneath the trailer. This puts the body of the person in an awkward pulling position. Many times, injuries may occur as the puller may injury his shoulder due to the awkward pulling position. Alternatively, the puller may hit his head on the trailer since the puller's head is positioned underneath the trailer when pulling.

Therefore, it would be desirable to provide a system and method that overcomes the above.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

A device for pulling and or twisting a release arm on a side of a fifth wheel of a tractor to release the tractor from the trailer has an elongated hollow body member. A hook member is attached to a bottom section of the elongated hollow body member. A rod member is positioned within the elongated hollow body member, wherein the rod member moved up and down within the elongated hollow body member. A locking mechanism is used to lock the rod member in a retracted position within the elongated hollow body member and in an extended position within the elongated hollow body member.

A device for pulling and or twisting a release arm on a side of a fifth wheel of a tractor to release the tractor from the trailer has an elongated hollow cylindrical body member. A hook member is attached to a bottom section of the hook member. A rod member is positioned within the elongated hollow body member, wherein the rod member moved up and down within the elongated hollow body member. A handle is attached to a top section of the rod member. A locking mechanism is used to lock the rod member in a retracted position within the elongated hollow body member and in an extended position within the elongated hollow body member.

A device for pulling and or twisting a release arm on a side of a fifth wheel of a tractor to release the tractor from the trailer has an elongated hollow body member. A hook member is attached to a bottom section of the elongated hollow body member. A rod member is positioned within the elongated hollow body member, wherein the rod member moved up and down within the elongated hollow body member. A handle is attached to a top section of the rod member. A locking mechanism is used to lock the rod member in a retracted position within the elongated hollow body member and an extended position within the elongated hollow body member. The locking mechanism has a first end cap attached to a bottom section of the elongated hollow body member. A second end cap is attached to a top section of the elongated hollow body member. A locking device is attached to a bottom end of the rod member that engages the first end cap to lock the device in an extended position and that engages the second end cap to lock the device in a retracted position.

The features, functions, and advantages may be achieved independently in various embodiments of the disclosure or may be combined in yet other embodiments.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a side vice of the device of the present invention in a retracted position;

FIG. 2 is a side view of the device of the present invention in an extended position;

FIG. 3 is an exploded cross-sectional side view of the device of the present invention;

FIG. 4A is a top view of the device of the present invention;

FIG. 4B is a top view of the device of the present invention with the handle rotated 90° clockwise; and

FIG. 4C is a top view of the device of the present invention with the handle rotated 90° counterclockwise.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

Referring to Figures a device 10 is shown for pulling and or twisting a release arm on a side of a fifth wheel of a tractor 12 to release the tractor 12 from the trailer 14. The device 10 may be formed of a body member 16. The body member 16 may be formed in different geometrical shapes. In accordance with one embodiment, the body member 16 may be formed of a hollow cylindrical member. In general, a sturdy material such as steel or the like may be used for the body member 16.

The device 10 has a pair of end caps 18. A first end cap 18A is positioned on a bottom end 16A of the tubular body member 16. A second end cap 18B is positioned on a top end 16B of the tubular body member 16. In accordance with one embodiment, the end caps 18 are of a diameter to be positioned within and secured to each end of the tubular body member 16.

The device 10 may have a hook member 20. The hook member 20 may be coupled to the bottom end 16A of the tubular body member 16. Alternatively, the hook member 20 may be coupled to one end of the first end cap 18A. In this embodiment, a channel 18B may be formed in a bottom section of the first end cap 18A. A top section of the hook member 20 may be inserted and attached within the channel 16B. The hook member 16 may be used to latch on to the release arm on the side of a fifth wheel of a tractor 12 thereby allowing a user of the device 10 to pull and or twist the release arm to release the tractor 12 from the trailer 14.

A rod member 22 may be positioned in the tubular body member 16. A handle 24 may be attached to a top end 22A of the rod member 22. The handle 24 may be used to provide an area for the user to grab the rod member 22 to pull and push the rod member 22 within the tubular body member 16.

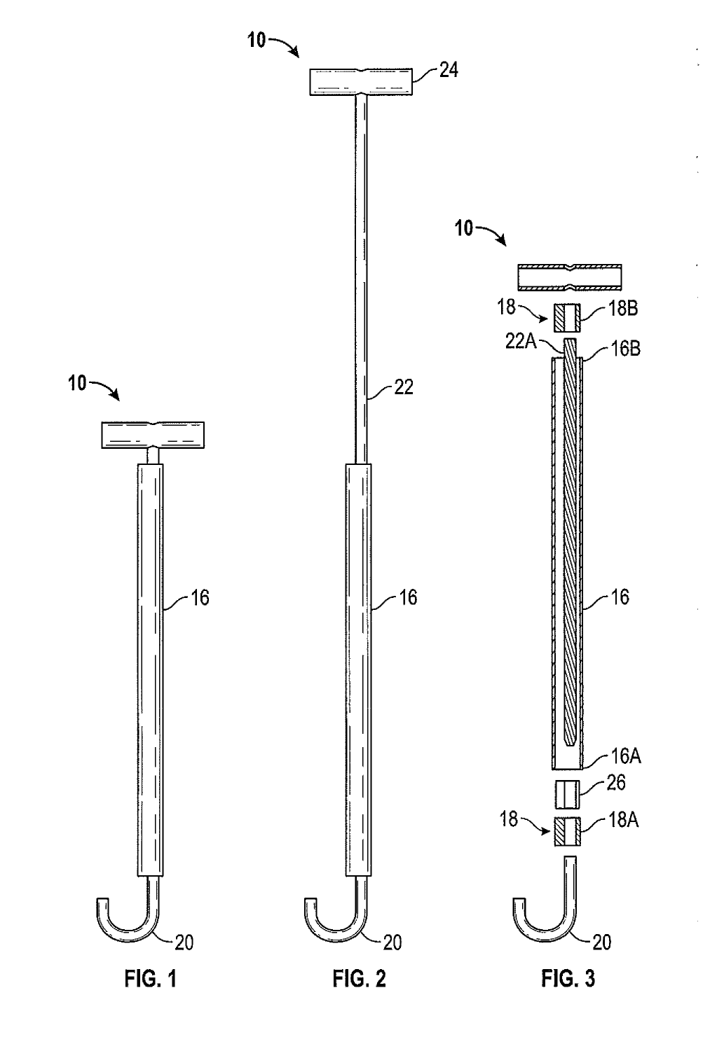

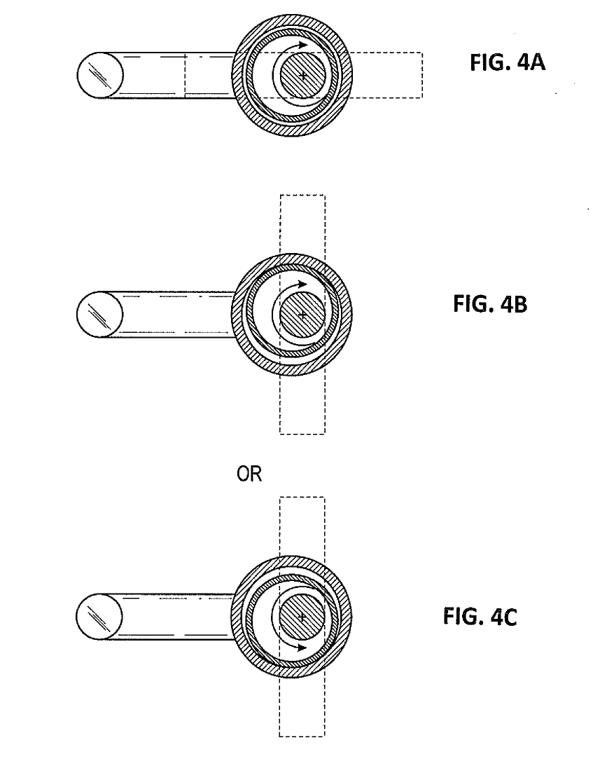

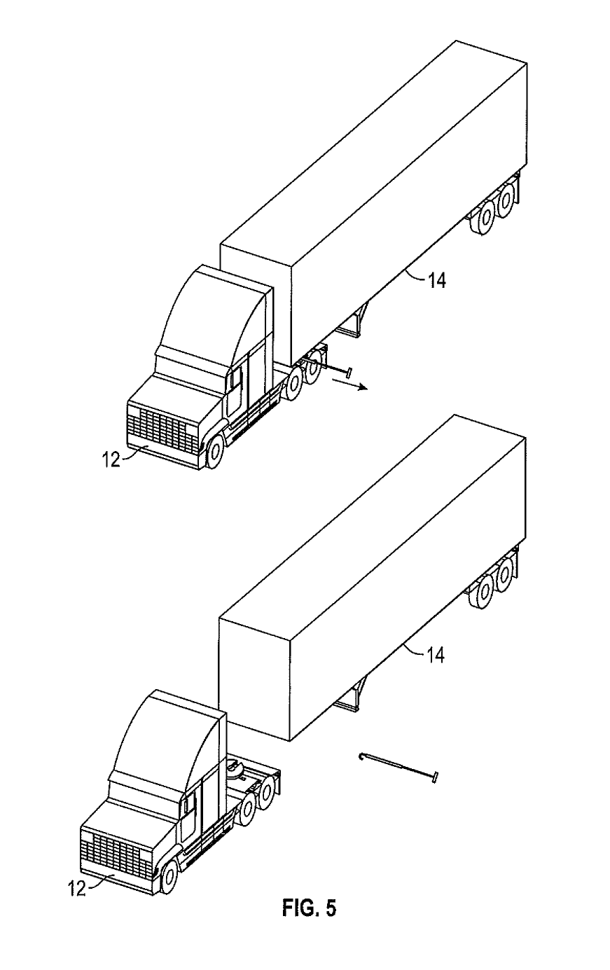

A locking member 26 may be attached to a bottom end 22B of the rod member 22. The locking member may be used to secure the rod member 22 in a retracted position as shown in FIG. 1 or an extended position as shown in FIG. 3. In accordance with one embodiment, the locking member 26 may engage the first end cap 18A. By turning the rod member 22 clockwise or counterclockwise 90° as shown in FIGS. 4B and 4C, the user may release the locking member 26 from the first end cap 18A and pull the rod member 22 upward to an extend position as shown in FIG. 2. In the extended position, the locking member 26 may engage the second end cap 18B. By turning the rod member 22 clockwise or counterclockwise 90° such that the handle 24 is positioned as shown in FIG. 4A, the user may secure the locking member 26 to the second end cap 18B such that the device 10 is locked in the extended position as shown in FIG. 2. By turning the rod member 22 clockwise or counterclockwise 90° again, the user may release the locking member 26 from the second end cap 18B and push the rod member 22 back into the retracted position.

In the extended position, the locking member 26 may engage the second end cap 18B. By turning the rod member 22 clockwise or counterclockwise 90° such that the handle 24 is positioned as shown in FIG. 4A, the user may secure the locking member 26 to the second end cap 18B such that the device 10 is locked in the extended position as shown in FIG. 2.

The locking member 26 and the first and second end caps 18A and 18B respectively, may take on different forms. In accordance with one embodiment, the locking member 26 may have threading which engages threading on first and second end caps 18A and 18B. For example, the locking mechanism 26 may have threading located on an exterior surface thereof. The threading of the locking mechanism 26 may engage threading located within a channel of the first and second end caps 18A and 18B. Alternatively, locking mechanism 26 may have threading located on an interior channel thereof. The threading of the locking mechanism 26 may engage threading located on an exterior surface of the first and second end caps 18A and 18B.

In accordance with another embodiment of the present invention, the locking member 26 may be formed having a geometric shape. The geometric shape of the locking member 26 engages cut-outs formed on first and second end caps 18A and 18B. Turning the locking member 26 within one of cut-outs formed in first and second end caps 18A and 18B secures the locking member 26 within one of cut-outs formed in first and second end caps 18A and 18B while a second turn releases the locking member 26 from one of cut-outs formed in first and second end caps 18A and 18B.

When the device 10 is in an extended position, the user may use device 10 to release the tractor 12 from the trailer 14. The user may extend the device 10 such that the hook member 20 may be used to latch on to the release arm on the side of a fifth wheel of a tractor 12. Once latched, the user may pull on the handle 24 and or twist the device 10 to disconnect the release arm to release the tractor 12 from the trailer 14.

While embodiments of the disclosure have been described in terms of various specific embodiments, those skilled in the art will recognize that the embodiments of the disclosure may be practiced with modifications within the spirit and scope of the claims.

What is claimed is:

1. A device for pulling and or twisting a release arm on a side of a fifth wheel of a tractor to release the tractor from the trailer comprising:
an elongated hollow body member;
a hook member attached to a bottom section of the elongated hollow body member;
a rod member positioned within the elongated hollow body member, wherein the rod member moved up and down within the elongated hollow body member; and
a locking mechanism to lock the rod member in a retracted position within the elongated hollow body member and in an extended position within the elongated hollow body member.

2. The device of claim 1, further comprising a handle attached to a top section of the rod member.

3. The device of claim 1, wherein the elongated hollow body member is tubular in shape.

4. The device of claim 1, wherein the locking mechanism comprises:
a first end cap attached to a bottom section of the elongated hollow body member;
a second end cap attached to a top section of the elongated hollow body member; and
a locking device attached to a bottom end of the rod member that engages the first end cap to lock the device in an extended position and that engages the second end cap to lock the device in a retracted position.

5. The device of claim 4, wherein rotation of the locking device clockwise or counterclockwise causes the locking device to engage one of the first end cap or second end cap.

6. The device of claim 4, wherein the first end cap is attached to the hook member.

7. The device of claim 1, wherein the locking mechanism comprises:
a first end cap attached to a bottom section of the elongated hollow body member and having a first end cap channel having threading;
a second end cap attached to a top section of the elongated hollow body member and having a second end cap channel with threading; and
a locking device attached to a bottom end of the rod member and having a locking device threading which engages the first end cap channel having threading and the second end cap channel having threading.

8. A device for pulling and or twisting a release arm on a side of a fifth wheel of a tractor to release the tractor from the trailer comprising:
an elongated hollow cylindrical body member;
a hook member attached to a bottom section of the hook member;
a rod member positioned within the elongated hollow body member, wherein the rod member moved up and down within the elongated hollow body member;
a handle attached to a top section of the rod member; and
a locking mechanism to lock the rod member in a retracted position within the elongated hollow body member and in an extended position within the elongated hollow body member.

9. The device of claim 8, wherein the locking mechanism comprises:
a first end cap attached to a bottom section of the elongated hollow body member;
a second end cap attached to a top section of the elongated hollow body member; and
a locking device attached to a bottom end of the rod member that engages the first end cap to lock the device in an extended position and that engages the second end cap to lock the device in a retracted position.

10. The device of claim 9, wherein rotation of the locking device clockwise or counterclockwise causes the locking device to engage one of the first end cap or second end cap.

11. The device of claim 10, wherein the first end cap and the second end cap each have threading which engages threading on the locking device.

12. The device of claim 9, wherein the first end cap is attached to the hook member.

13. The device of claim 8, wherein the locking mechanism comprises:
a first end cap attached to a bottom section of the elongated hollow body member and having a first end cap channel having threading;
a second end cap attached to a top section of the elongated hollow body member and having a second end cap channel with threading; and
a locking device attached to a bottom end of the rod member and having a locking device threading which engages the first end cap channel having threading and the second end cap channel having threading.

14. A device for pulling and or twisting a release arm on a side of a fifth wheel of a tractor to release the tractor from the trailer comprising:
an elongated hollow body member;
a hook member attached to a bottom section of the elongated hollow body member;
a rod member positioned within the elongated hollow body member, wherein the rod member moved up and down within the elongated hollow body member;
a handle attached to a top section of the rod member; and
a locking mechanism to lock the rod member in a retracted position within the elongated hollow body member and an extended position within the elongated hollow body member wherein the locking mechanism comprises:
a first end cap attached to a bottom section of the elongated hollow body member;
a second end cap attached to a top section of the elongated hollow body member; and
a locking device attached to a bottom end of the rod member that engages the first end cap to lock the device in an extended position and that engages the second end cap to lock the device in a retracted position.

15. The device of claim 14, wherein the elongated hollow body member is tubular in shape.

16. The device of claim 14, wherein rotation of the locking device clockwise or counterclockwise causes the locking device to engage one of the first end cap or second end cap.

17. The device of claim 14, wherein the first end cap is attached to the hook member.
